(19) United States
(12) Patent Application Publication
(10) Pub. No.: US 2025/0208587 A1
(43) Pub. Date: Jun. 26, 2025

(54) METHOD FOR CONTROLLING AN AUTOMATIC SCREWDRIVING MACHINE

(71) Applicant: Weber Schraubautomaten GmbH, Wolfratshausen (DE)

(72) Inventors: Nora ERDEI, Münsing (DE); Robert STÜTZER, München (DE)

(21) Appl. No.: 18/848,619

(22) PCT Filed: Mar. 20, 2024
(86) PCT No.: PCT/EP2023/057072

§ 371 Date: Sep. 19, 2024

(30) Foreign Application Priority Data
Mar. 22, 2022 (DE) 10 2022 106 711.4

(51) Int. Cl. G05B 13/02

(52) U.S. Cl. CPC G05B 13/0265

(57) ABSTRACT

The invention relates to a method for controlling an automatic screwdriving machine that comprises: a screwdriving unit for the automated screwing of a screw into a component; and a control unit for controlling the screwdriving unit based on a screwdriving program that is stored in the control unit and that defines the time development of a desired rotational speed at which the screw is to be driven during the screwdriving process and, optionally, also defines the time development of a feed force to be exerted on the screw during a screwdriving process, wherein, during a screwdriving process, the control unit records a data set that relates to the screwdriving process and that comprises the time developments of the following screwdriving parameters: an actual rotational speed of the screw, a torque exerted on the screw, a feed position of the screw and a feed speed of the screw. The control unit transmits the recorded data set to a remote data processing unit in which the screwdriving process is evaluated by means of artificial intelligence based on the transmitted data set.

The invention relates to a method for controlling an automatic screwdriving machine that comprises: a screwdriving unit for the automated screwing of a screw into a component; and a control unit for controlling the screwdriving unit based on a screwdriving program that is stored in the control unit and that defines the time development of a desired rotational speed at which the screw is to be driven during the screwdriving process and, optionally, also defines the time development of a feed force to be exerted on the screw during a screwdriving process, wherein, during a screwdriving process, the control unit records a data set that relates to the screwdriving process and that comprises the time developments of the following screwdriving parameters: an actual rotational speed of the screw, a torque exerted on the screw, a feed position of the screw and a feed speed of the screw.

A method of this kind is generally known. In this respect, it is possible for an experienced screw expert to recognize, based on the recorded data set, what type of screwdriving process was performed, for example whether it was a metric screw element (with a standard thread, a fine thread and/or a screw locking device) or a self-tapping screw element, whether the latter was screwed into a sheet metal or a blind hole and what type of material it was screwed into (e.g. plastic, aluminum, steel). If a sample data set resulting from an error-free screwdriving process is available to the screw expert, the screw expert can deduce possible reasons from a deviating data set that have led to a faulty screw connection or will lead to one in the future.

It is understood that the quality of such a data set analysis and error diagnosis depends not only on the experience of the screw expert, but also on the availability of a screw expert in the first place. If an end customer has purchased an automatic screwdriving machine but does not have the financial and/or personnel resources to afford their own screw expert, the end customer can, for example, conclude a service contract with the manufacturer of the automatic screwdriving machine that includes a regular and/or on-demand quality check or error diagnosis. In the event of a regular service appointment and/or if an error has occurred, a service technician of the manufacturer would then travel to the end customer and service the automatic screwdriving machine and, if necessary, attempt to rectify existing errors. It is understood that the further away the end customer is from the manufacturer, the greater the cost and time involved with such a service appointment is, in particular if the manufacturer and the end customer are located in different countries or even on different continents.

It is the underlying object of the invention to provide a more reliable, economic and user-friendly method for controlling an automatic screwdriving machine.

The object is satisfied by a method having the features of claim 1, and in particular in that the control unit transmits the recorded data set to a remote data processing unit in which the screwdriving process is evaluated by means of artificial intelligence based on the transmitted data set.

In this context, a remote data processing unit is to be understood as a data processing unit that is not located at the same location as the automatic screwdriving machine, in particular not on the same premises. The data processing unit may be located in a different city, in a different country or even on a different continent than the automatic screwdriving machine. For example, the data processing unit can be operated by the manufacturer of the automatic screwdriving machine, while the automatic screwdriving machine is used by an end customer. Due to the physical distance between the automatic screwdriving machine and the data processing unit, the communication between them preferably takes place via a remote data connection that can include the internet, for example.

Due to the evaluation of the data set recorded in the automatic screwdriving machine and transmitted to the data processing unit by means of artificial intelligence, screwdriving processes performed by the automatic screwdriving machine can be analyzed independently of the individual experience and competence of a service technician and thus tend to be analyzed with a higher accuracy and reliability. Furthermore, it is not absolutely necessary to send a service technician to the end customer, for example, to correct a faulty screwdriving process, to optimize a screwdriving process that is working per se or to implement an innovative screwdriving process. Instead, these tasks can be efficiently and reliably solved remotely by means of artificial intelligence, whereby time and costs can be saved in a customer-friendly manner.

Advantageous further developments of the invention can be seen from the dependent claims, from the description and from the drawing.

According to one embodiment, the artificial intelligence is formed by a machine learning algorithm, for example by a decision tree algorithm, a random forest algorithm, a support vector machine (SVM) algorithm or a k-nearest neighbors (kNN) algorithm.

According to a further embodiment, the artificial intelligence was trained using a plurality of heterogeneous data sets. In this context, heterogeneous data sets are to be understood as data sets that result from a wide variety of screwdriving processes, for example from screwdriving processes in which metric screws with different threads and with or without a securing are screwed into threaded bores or in which self-tapping screws are screwed into blind holes or sheet metals made of different materials. Heterogeneous data sets must therefore be distinguished from homogeneous data sets that are obtained using a single type of screwdriving process, i.e. in which the same type of screws are always screwed into the same type of components.

To be able to supply the artificial intelligence with a large amount of data, on the one hand, and to be able to analyze performed screwdriving processes at a later point in time, on the other hand, it is advantageous if the recorded data set is stored in a memory of the control unit for a predetermined time period of, for example, several days, weeks or months, or even permanently.

It is generally conceivable that, after completion of each screwdriving process, the control unit transmits the associated data set to the data processing unit or that a transmission of a plurality of data sets takes place automatically at predefined time intervals. However, this requires a permanent or at least temporary, in particular automatically established, communication between the automatic screwdriving machine and the data processing unit, which is not necessarily desirable from the point of view of the user of the automatic screwdriving machine. In many cases, it is therefore advantageous if the control unit transmits the recorded data set to the remote data processing unit at the instruction of a user of the automatic screwdriving machine.

To improve the quality of the evaluation by the artificial intelligence, the control unit can transmit at least a first data set associated with an error-free screwdriving process and at least a second data set associated with a faulty screwdriving process to the remote data processing unit at the instruction of a user of the automatic screwdriving machine. The artificial intelligence preferably identifies an error that occurred during the faulty screwdriving process by evaluating the first and second data set. The artificial intelligence so-to-say carries out a target/actual comparison, on the basis of which an error that occurred during the faulty screwdriving process can be identified more reliably. In the event of uncertainty, for example if the artificial intelligence is less than 80% sure what the error was, an interaction with the user can take place, in which the user has the option of providing the artificial intelligence with additional data. The result of the evaluation can then be made available to the user of the automatic screwdriving machine by the remote data processing unit transmitting feedback indicating the identified error to the automatic screwdriving machine. The feedback can in particular comprise a suggestion for rectifying the error so that the user can correct or adapt the screwdriving process accordingly.

According to a further embodiment, the control unit can transmit a plurality of data sets, in particular a plurality of data sets associated with error-free screwdriving processes, and a user-defined specification for optimizing the screwdriving process to the remote data processing unit at the instruction of a user of the automatic screwdriving machine. A specification for optimizing the screwdriving process can, for example, consist of an increased cycle time and/or a higher quality of the screw connection. Based on the plurality of transmitted data sets and considering the transmitted optimization specification, the artificial intelligence can then create a suggestion for at least one changed machine setting and/or for a changed screwdriving program. In the event of uncertainty, for example if the artificial intelligence is less than 80% sure of a suitable change, an interaction with the user can also take place here, in which the user has the option of providing the artificial intelligence with additional data. The suggestion for the at least one changed machine setting and/or for the changed screwdriving program can then be transmitted from the remote data processing unit to the control unit of the automatic screwdriving machine so that the user can make the suggested changes and perform a correspondingly optimized screwdriving process.

According to yet a further embodiment, a user of the automatic screwdriving machine can define requirements for an innovative screwdriving process and can enter them into the control unit. An innovative screwdriving process can, for example, involve the use of a different screw or the use of a different material to be screwed into. The control unit transmits the user-defined requirements to the remote data processing unit and the artificial intelligence determines a screwdriving program that matches the user-defined requirements and that is then transmitted from the remote data processing unit to the control unit of the automatic screwdriving machine in order to perform the innovative screwdriving process. During the performance of the innovative screwdriving process, a data set relating to the screwdriving process can, as already explained above, be recorded and can be transmitted to the data processing unit after completion of the screwdriving process to be evaluated by the artificial intelligence so that the latter can, if necessary, determine a suggestion for optimizing the screwdriving program and/or a machine setting, said suggestion then being transmitted back to the control unit of the automatic screwdriving machine.

A further subject of the invention is a system for controlling an automatic screwdriving machine, said automatic screwdriving machine comprising a screwdriving unit for the automated screwing of a screw into a component; and a control unit for controlling the screwdriving unit based on a screwdriving program that is stored in the control unit and that defines the time development of a desired rotational speed at which the screw is to be driven during the screwdriving process and, optionally, also defines the time development of a feed force to be exerted on the screw during a screwdriving process. The control unit is configured, during a screwdriving process, to record a data set that relates to the screwdriving process and that comprises the time developments of the following screwdriving parameters: an actual rotational speed of the screw, a torque exerted on the screw, a feed position of the screw and a feed speed of the screw. The system further comprises a remote data processing unit which has artificial intelligence, to which the recorded data set can be transmitted by the control unit and in which the screwdriving process can be evaluated by means of the artificial intelligence based on the transmitted data set.

The invention will be described in more detail in the following purely by way of example with reference to different embodiments and to the enclosed drawing. There are shown:

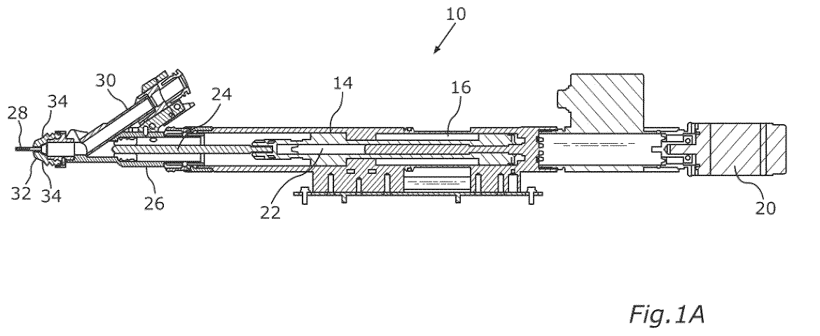

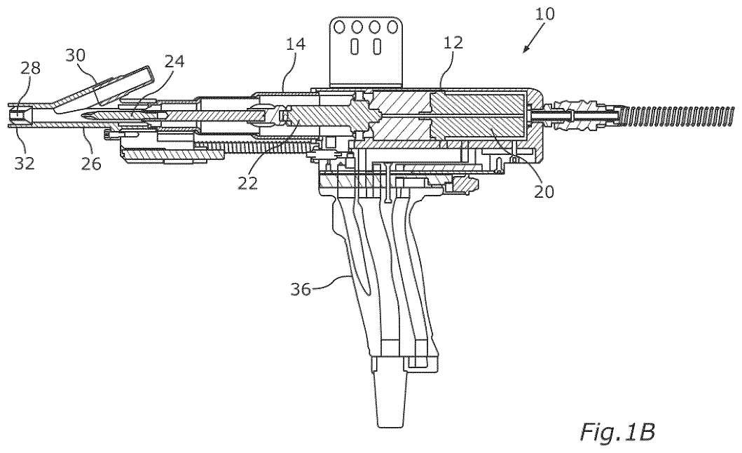

FIG. 1A a sectional view of a first embodiment of an automatic screwdriving machine for automatically performing screwdriving processes;

FIG. 1B a sectional view of a second embodiment of an automatic screwdriving machine for automatically performing screwdriving processes;

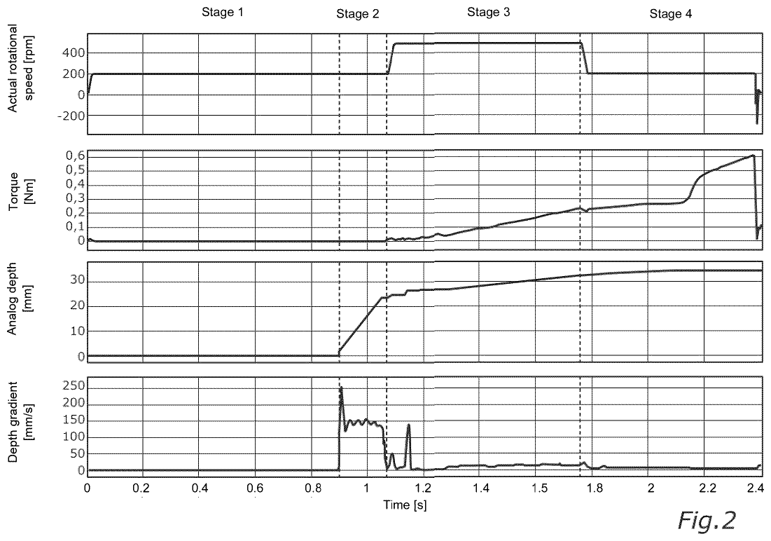

FIG. 2 a data set comprising four screwing curves and resulting from a thread-forming screw connection;

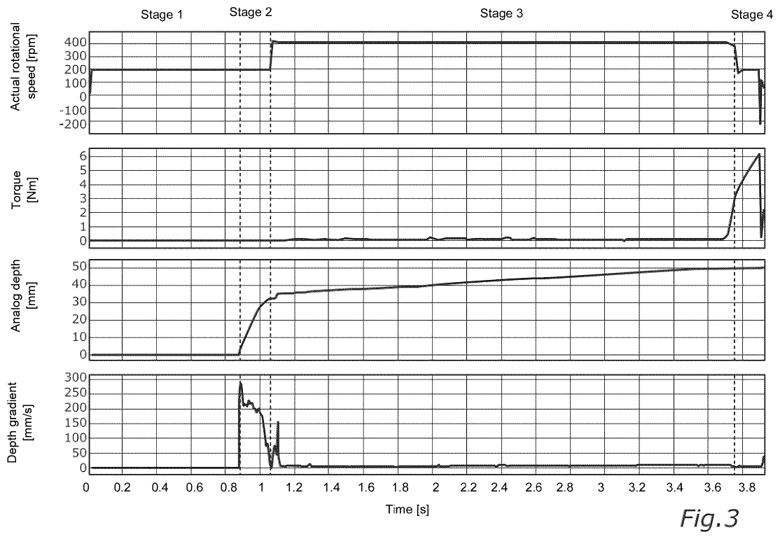

FIG. 3 a data set comprising four screwing curves and resulting from a metric screw connection; and

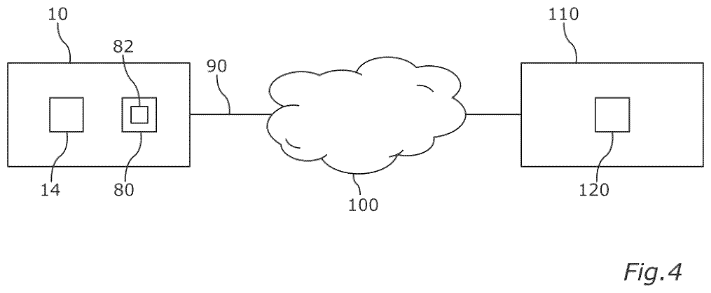

FIG. 4 schematically, the automatic screwdriving machine of FIG. 1 in a communication connection with a remote data processing unit.

FIG. 1 shows a first embodiment of an automatic screwdriving machine 10 for automatically performing screwdriving processes.

The automatic screwdriving machine 10 comprises a base unit 12 that can be mounted at a handling apparatus, not shown, for example at a robot arm. Therefore, the automatic screwdriving machine 10 of FIG. 1A is also referred to below as a robot-bound automatic screwdriving machine 10.

The base unit 12 supports a screwdriving unit 14 that can be moved in a feed direction relative to the base unit 12 by means of a pneumatic or hydraulic feed cylinder 16 of the base unit 12. It is understood that the screwdriving unit 14 can alternatively also be fed by means of an electric drive.

The screwdriving unit 14 comprises a drive motor 20 that rotationally drives a screwing tool 24 via a drive shaft 22 extending in the feed direction and that is displaceably supported in a positioning head 26 in the feed direction.

To perform a screwdriving process, the automatic screwdriving machine 10 is first positioned by the handling apparatus at a small distance, e.g. at a distance of approximately 20 mm, in front of two components to be screwed together, not shown here.

A screw 28 provided for the screw connection is fed to the positioning head 26 by means of a feed device 30. To align and hold the screw 28 in a defined screwing position, the positioning head 26 has a holding mechanism 32 that comprises two jaw arms 34 that, at oppositely disposed sides of the positioning head 26, are rotatably supported at the positioning head 26, in each case about an axis of rotation oriented at a right angle to the feed direction, and that can be pressed apart against the return force of a spring to release the screw 28.

After the positioning of the automatic screwdriving machine 10 in front of the components, the screwdriving unit 14 and thus the screw 28 are fed towards the components by actuating the feed cylinder 16 until the screw 28 is supported at one of the components.

Next, the screwdriving unit 14 is advanced by the feed cylinder 16 to bring the screwing tool 24 into engagement with the screw 28. The screwing tool 24 here rotates at a low rotational speed at best.

As soon as the screwing tool 24 is in engagement with the screw 28, the rotational speed of the screwing tool 24 and thus of the screw 28 is increased to a desired rotational speed in order to screw the screw 28 into the components while exerting a feed force predefined by the feed cylinder 16.

It is understood that the automatic screwdriving machine 10 does not necessarily have to be robot-bound, but can also be hand-guided and can have a handle 36 for this purpose. An embodiment of such a hand-guided automatic screwdriving machine 10 is shown in FIG. 1B and, similarly to the robot-bound automatic screwdriving machine 10 of FIG. 1A, has a screwdriving unit 14 comprising a drive motor 20 that rotationally drives a screwing tool 24 via a drive shaft 22, said screwing tool 24 being displaceably supported in a positioning head 26 in the feed direction. Furthermore, the hand-guided automatic screwdriving machine 10 of FIG. 1B is also provided with a feed device 30 for feeding a screw 28 to a positioning head 26 of the automatic screwdriving machine 10. In contrast to the robot-bound automatic screwdriving machine 10 of FIG. 1A, the hand-guided automatic screwdriving machine 10 of FIG. 1B, however, does not have a feed cylinder 16 since the required feed force is exerted manually here.

In both embodiments, the screwdriving unit 14 is controlled by a control unit 80 (FIG. 4) of the automatic screwdriving machine 10, in which control unit 80 at least one screwdriving program is stored that defines the time development of a desired rotational speed at which the screwing tool 24 and thus the screw 28 are to be driven during a screwdriving process. In the case of the robot-bound automatic screwdriving machine 10 of FIG. 1A, the screwdriving program furthermore defines the time development of a feed force to be exerted by the feed cylinder 16 on the screwing tool 24 and thus on the screw 28 during the screwdriving process.

Furthermore, during a screwdriving process, the control unit 80 records a data set that relates to the screwdriving process and that comprises the time developments of the following screwdriving parameters: the actual rotational speed of the screwing tool 24 and thus of the screw 28 detected by means of a suitable sensor, the torque that is detected by means of a suitable sensor and that is exerted on the screw 28, the feed position of the screwing tool 24 and thus of the screw 28 that is detected by means of a suitable sensor, and the time derivative of the detected feed position, i.e. the feed speed of the screw 28, also designated as depth gradient in this context. Each recorded data set is stored in a memory 82 of the control unit 80 for analysis purposes for a predetermined time period of, for example, several days, weeks or months, or even permanently.

FIG. 2 shows an example of such a data set that was recorded during a thread-forming screwdriving process in which a self-tapping screw 28 is screwed into at least one component. The data set comprises four screwing curves that-from top to bottom-show the actual rotational speed of the screwing tool 24 and thus of the screw 28 in rpm, the torque exerted on the screwing tool 24 and thus on the screw 28 in Nm, the feed position of the screwing tool 24 and thus of the screw 28, designated as analog depth here, in mm and the time derivative of the feed position, i.e. the feed speed or the depth gradient, in mm/s.

Based on the recorded screwing curves, the screwdriving process can be temporally divided into four stages, namely a stage 1 which lasts 0.9 seconds here and during which the screw 28 is moved at a low rotational speed of 200 rpm here towards the components to be screwed together until the screw tip impacts the surface of one of the components, a stage 2 during which the screw 28 penetrates the component comparatively quickly over approximately 0.2 seconds at a still low rotational speed of 200 rpm here, a stage 3 lasting approximately 0.7 seconds during which the screw 28 penetrates comparatively slowly deeper into the component at an increased rotational speed of 500 rpm here, and a stage 4 lasting approximately 0.6 seconds during which the screw 28 is slowly screwed further into the component again at a reduced rotational speed of 200 rpm here until the detected torque reaches a maximum value of 0.6 Nm here and the screwdriving process is stopped by reducing the rotational speed to 0 rpm. The screwdriving process takes approximately 2.4 seconds in total and, after completion of the screwdriving process, the screw 28 has penetrated approximately 33 mm deep into the component.

For comparison, FIG. 3 shows a data set that was recorded during a screwdriving process in which a metric screw 28 was screwed through a pre-punched hole in a facing component into a corresponding threaded bore provided in a facing-away component. This data set also comprises four screwing curves that-from top to bottom-show the actual rotational speed of the screwing tool 24 and thus of the screw 28 in rpm, the torque exerted on the screwing tool 24 and thus on the screw 28 in Nm, the feed position of the screwing tool 24 and thus of the screw 28, designated as analog depth here, in mm and the time derivative of the feed position, i.e. the feed speed or the depth gradient, in mm/s.

By comparing the screwing curves shown in FIG. 2 and FIG. 3, it is easy to see that the process of the metric screw connection shown in FIG. 3 differs significantly in some aspects from the thread-forming screw connection shown in FIG. 2. For example, the metric screwdriving process of FIG. 3 with a total of almost 4 seconds lasts significantly longer than the thread-forming screwdriving process of FIG. 2, which is connected, on the one hand, to the fact that the metric screw 28 has a length of 50 mm here and thus has to be driven 50 mm deep into the component and, on the other hand, to the fact that the increased rotational speed during stage 3 is only 280 revolutions/min. Another significant difference is that the metric screw 28 can be tightened with a maximum torque of 6 Nm at the end of the screwdriving process, i.e. approximately ten times as tight as the self-tapping screw 28 of FIG. 2.

In other words, by comparing recorded data sets, it can be determined whether they are based on similar or different screwdriving processes. Based on characteristic features of the individual screwing curves of a data set, it is even possible to deduce whether the underlying screwdriving process is a thread-forming or metric screw connection, how long the used screw is, how large the thread pitch and the shank diameter of the screw are, and—in the case of a self-tapping screw—into what type of material it was screwed.

As FIG. 4 shows, the automatic screwdriving machine 10 can be temporarily connectable or also permanently connected to a remote data processing unit 110 via a remote data connection 90 that can include the internet 100, for example. The data processing unit 110 can, for example, be located at the manufacturer of the automatic screwdriving machine 10 and can be in a different city or country or even on a different continent than the automatic screwdriving machine 10. Via the remote data connection 90, data sets of the kind that is described above and shown by way of example in FIGS. 2 and 3 can be transmitted by the control unit 14 of the automatic screwdriving machine 10 to the data processing unit 110 for analysis purposes. Conversely, the data processing unit 110 can send recommendations for correcting faulty screwdriving processes, faulty machine settings, optimized screwdriving programs or even new screwdriving programs to the control unit 14 of the automatic screwdriving machine 10 after evaluating transmitted data sets.

Specifically, to evaluate a transmitted data set, the data processing unit 110 uses an artificial intelligence 120 that can be formed by a machine learning algorithm, for example by a decision tree algorithm, a random forest algorithm, a support vector machine (SVM) algorithm or a k-nearest neighbor (kNN) algorithm, and that has been trained using a plurality of heterogeneous data sets, i.e. using a plurality of data sets based on a wide variety of screwdriving processes that comprise both metric and thread-forming screw connections, each of which has been implemented using screws of different lengths with different thread pitches and shank diameters and in different materials.

In this way, the artificial intelligence 120 is not only trained or specialized for a specific screwdriving process, but is also able to use the aforementioned characteristic features of the screwing curves of a recorded data set not only to correctly classify the underlying screwdriving process with a high probability, but also to correctly identify the error(s) with a high probability in the event of an incorrectly performed screwdriving process, in particular if, in addition to a data set associated with a faulty screwdriving process, a data set associated with a corresponding error-free screwdriving process is available.

If, for example, a user of the automatic screwdriving machine 10 discovers a faulty screw connection and the user is unwilling or unable to determine the cause of the faulty screw connection himself, the user can transmit the data set associated with the faulty screw connection together with a data set associated with an error-free screw connection to the data processing unit 110. The artificial intelligence 120 of the data processing unit 110 identifies an error that occurred during the faulty screwdriving process by comparing the transmitted data sets and the data processing unit 110 transmits feedback indicating the identified error to the control unit 14 of the automatic screwdriving machine 10, wherein this feedback can in particular comprise a suggestion for rectifying the error. Such a suggestion for rectifying the error could, for example, consist in recommending using a different type of screw or increasing or reducing the maximum torque at the end of the screwdriving process. If the artificial intelligence 120 is uncertain when identifying the error, for example less than 80% certain, an interaction with the user can take place, in which the user has the option of providing the artificial intelligence 120 with additional data.

A situation is also conceivable in which the user of the automatic screwdriving machine 10 desires an optimization of an existing screwdriving process, for example in the form of an increased cycle time and/or a higher quality of the screw connection. To solve this optimization task, the user can transmit a plurality of data sets, which ideally result from error-free screw connections, to the data processing unit 110. The artificial intelligence 120 can evaluate the transmitted data sets, considering the likewise transmitted optimization specification, and can create a suggestion for at least one changed machine setting or for a changed screwdriving program. In the event of uncertainty, for example if the artificial intelligence 120 is less than 80% sure of the required changes, an interaction with the user can also take place here, in which the user has the option of providing the artificial intelligence with additional data. The suggestion for the at least one changed machine setting or for the changed screwdriving program can then be transmitted from the remote data processing unit 110 to the control unit 14 of the automatic screwdriving machine 10 so that the user can make the suggested changes and can perform a correspondingly optimized screwdriving process.

A situation is further conceivable in which a user of the automatic screwdriving machine 10 defines requirements for an innovative screwdriving process and enters them into the control unit 14. An innovative screwdriving process can, for example, involve the use of a different screw or the use of components of a material that are to be screwed together. The control unit 14 can transmit the user-defined requirements to the remote data processing unit 110 and the artificial intelligence 120 determines a screwdriving program that matches the user-defined requirements and that is then transmitted from the remote data processing unit 110 to the control unit 14 of the automatic screwdriving machine 10 to perform the innovative screwdriving process. During the performance of the innovative screwdriving process, a data set relating to the screwdriving process can, as explained above, be recorded and is transmitted to the data processing unit 110 after completion of the screwdriving process to be evaluated by the artificial intelligence 120 so that the latter can, if necessary, determine a suggestion for optimizing the screwdriving program and/or a machine setting, said suggestion then being transmitted back to the control unit 14 of the automatic screwdriving machine 10.

### REFERENCE NUMERAL LIST

10 automatic screwdriving machine
12 base unit
14 screwdriving unit
16 feed cylinder
20 drive motor
22 drive shaft
24 screwing tool
26 positioning head
28 screw
30 feed device
32 holding mechanism
34 jaw arms
36 handle
80 control unit
82 memory
90 remote data connection
100 internet
110 data processing unit
120 artificial intelligence

1-13. (canceled)

14. A method for controlling an automatic screwdriving machine that comprises:
a screwdriving unit for the automated screwing of a screw into a component; and
a control unit for controlling the screwdriving unit based on a screwdriving program that is stored in the control unit and that defines the time development of a desired rotational speed at which the screw is to be driven during the screwdriving process,
wherein, during a screwdriving process, the control unit records a data set that relates to the screwdriving process and that comprises the time developments of the following screwdriving parameters: an actual rotational speed of the screw, a torque exerted on the screw, a feed position of the screw and a feed speed of the screw,
wherein the control unit transmits the recorded data set to a remote data processing unit in which the screwdriving process is evaluated by means of artificial intelligence based on the transmitted data set.

15. The method according to claim 14,
wherein the artificial intelligence is formed by a machine learning algorithm.

16. The method according to claim 14,
wherein the artificial intelligence was trained using a plurality of heterogeneous data sets.

17. The method according to claim 14,
wherein the recorded data set is stored for a predetermined time period or also permanently in a memory of the control unit.

18. The method according to claim 14,
wherein the control unit transmits the recorded data set to the remote data processing unit at the instruction of a user of the automatic screwdriving machine.

19. The method according to claim 14,
wherein the control unit transmits at least a first data set associated with an error-free screwdriving process and at least a second data set associated with a faulty screwdriving process to the remote data processing unit at the instruction of a user of the automatic screwdriving machine.

20. The method according to claim 19,
wherein the artificial intelligence identifies an error that occurred during the faulty screwdriving process by evaluating the first and second data set.

21. The method according to claim 20,
wherein the remote data processing unit transmits feedback indicating the identified error to the automatic screwdriving machine.

22. The method according to claim 14,
wherein the control unit transmits a plurality of data sets and a user-defined specification for optimizing the screwdriving process to the remote data processing unit at the instruction of a user of the automatic screwdriving machine.

23. The method according to claim 22,
wherein the artificial intelligence creates a suggestion for at least one changed machine setting and/or for a changed screwdriving program based on the plurality of transmitted data sets and considering the transmitted optimization specification, said suggestion being transmitted from the remote data processing unit to the control unit of the automatic screwdriving machine in order to perform an optimized screwdriving process.

24. The method according to claim 14,
wherein
a user of the automatic screwdriving machine defines requirements for an innovative screwdriving process and enters them into the control unit,
the control unit transmits the user-defined requirements to the remote data processing unit,
the artificial intelligence determines a screwdriving program that matches the user-defined requirements, and
the determined screwdriving program is transmitted from the remote data processing unit to the control unit of the automatic screwdriving machine in order to perform the innovative screwdriving process.

25. The method according to claim 24,
wherein a data set relating to the screwdriving process is recorded during the performance of the innovative screwdriving process by means of the determined screwdriving program,
the recorded data set is transmitted to the data processing unit and evaluated by the artificial intelligence,
the artificial intelligence determines a suggestion for an optimized screwdriving program and/or an optimized machine setting on the basis of the evaluation, and
the optimized screwdriving program and/or the optimized machine setting is/are transmitted from the data processing unit back to the control unit of the automatic screwdriving machine.

26. A system for controlling an automatic screwdriving machine, said automatic screwdriving machine comprising:
a screwdriving unit for the automated screwing of a screw into a component; and
a control unit for controlling the screwdriving unit based on a screwdriving program that is stored in the control unit and that defines the time development of a desired rotational speed at which the screw is to be driven during the screwdriving process,
wherein the control unit is configured, during a screwdriving process, to record a data set that relates to the screwdriving process and that comprises the time developments of the following screwdriving parameters: an actual rotational speed of the screw, a torque exerted on the screw, a feed position of the screw and a feed speed of the screw,
further comprising
a remote data processing unit which has artificial intelligence, to which the recorded data set can be transmitted by the control unit and in which the screwdriving process can be evaluated by means of the artificial intelligence based on the transmitted data set.

27. The method according to claim 14,
wherein the screwdriving program also defines the time development of a feed force to be exerted on the screw during a screwdriving process.

28. The method according to claim 15,
wherein the machine learning algorithm comprises a decision tree algorithm, a random forest algorithm, a support vector machine algorithm or a k-nearest neighbors algorithm.

29. The method according to claim 21,
wherein the feedback comprises a suggestion for rectifying the error.

30. The method according to claim 22,
wherein the plurality of data sets comprises a plurality of data sets associated with error-free screwdriving processes.

31. The system according to claim 26,
wherein the screwdriving program also defines the time development of a feed force to be exerted on the screw during a screwdriving process.
